(19) United States
(12) Patent Application Publication
(10) Pub. No.: US 2007/0161356 A1
(43) Pub. Date: Jul. 12, 2007

(54) Method and apparatus for improved carrier feed thru rejection for a linear amplifier

(76) Inventors: Bryan A. Hoon, Crystal Lake, IL (US); Scott R. Anderson, Barrington, IL (US); Kevin J. McCallum, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/331,249

(22) Filed: Jan. 12, 2006

(51) Int. Cl. H04B 17/00

(52) U.S. Cl. 455/115.1

(57) ABSTRACT

Improved carrier feed thru rejection is achieved for a linear amplifier in a transmitter. The DC training capabilities of a radio frequency mixer are used, not only to correct DC offset of the radio frequency mixer, but also to adjust the DC offset of any baseband circuit and filtering coupled to the radio frequency mixer. Output power adjustment is accomplished by adjusting a feedback attenuator in the feedback path of the radio frequency mixer. Constant loop gain is maintained by adjusting a forward attenuator in the forward path of the radio frequency mixer. The feedback and forward attenuators have a fine adjustment on the order of less than 5 dB.

### FIELD OF THE INVENTION

The invention generally relates to transmitters, and in particular, to improved carrier feed thru rejection for linear radio frequency transmitters.

### BACKGROUND OF THE INVENTION

Radio frequency transmitters modulate baseband signals, for example, voice signals, onto a radio frequency (RF) carrier, amplify the modulated RF carrier, and transmit the modulated RF carrier via an antenna over the air as electromagnetic energy. One problem with linear transmitters is carrier feed through (or thru). One component of carrier feed thru in a transmitter is baseband DC offset that is translated to the carrier frequency in the process of modulating the baseband signals with the radio frequency carrier. If this carrier feed thru component becomes excessive, it can degrade the overall transmitted signal quality.

Presently in transmitters, there may be up to three main DC offset contributors: the baseband circuit, baseband active filtering, and the up mix radio frequency circuit, also known as the radio frequency mixer. Combining the DC offsets of all these contributors produces a total baseband offset that usually degrades the carrier feed thru performance by increasing amplitude.

An exemplary linear transmitter includes a Cartesian feedback loop. One important consideration of Cartesian feedback loop design is stability. Generally, there are two criteria for stability of a Cartesian feedback loop. First, the gain margin should be greater than 0 dB. Second, the phase margin should be positive. Another important consideration of Cartesian feedback loop design is noise performance. Generally, noise performance of Cartesian feedback loops can be improved by keeping the loop bandwidth small. Of course, the loop bandwidth should still be made large enough to pass the communication signal being transmitted. The loop bandwidth, phase margin, gain margin and maximum loop gain are functions of the loop filter and gain of the amplifiers in the Cartesian feedback loop. The components of the feedback loop are chosen to make the loop bandwidth large enough to pass the communication signal but small enough to attenuate noise while maintaining stability and providing a large maximum loop gain.

One known solution for managing DC offset in a linear transmitter employing a Cartesian feedback loop is a power detection procedure that measures the carrier feed thru component when no channel data is present, that is, when the radio is dekeyed. Based on this measured power, the DC offset is adjusted in the baseband circuits to “null” or minimize the carrier feed thru component. This is a timely process that involves system downtime and adds cost. For example, this power detection scheme may take several milliseconds to complete. Also, adjusting the baseband circuits affects the efficiency of the transmitter. This is undesirable.

Therefore a need exists for a method and apparatus providing improved carrier feed thru rejection.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an apparatus for improved carrier feed thru rejection in accordance with an embodiment of the present invention; and

FIG. 2 is a flow diagram illustrating a method for improved carrier feed thru rejection in accordance with an embodiment of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to a method and apparatus for improving carrier feed thru rejection. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for improved carrier feed thru rejection described herein. The non-processor circuits may include, but are not limited to, a radio transmitter, signal drivers, clock circuits, power source circuits, amplifiers and user input devices. As such, these functions may be interpreted as steps of a method to improve carrier feed thru rejection described herein. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. Further, it is expected that one of ordinary skill, notwithstanding some effort and many design choices motivated by, for example, available time, current technology, and economic considerations, when guided by the concepts and principles disclosed herein will be readily capable of generating such software instructions and programs and integrated circuits with minimal experimentation.

Pursuant to the various embodiments, an apparatus for carrier feed thru rejection includes a radio frequency mixer that mixes a baseband signal with a radio frequency signal. The baseband signal is provided by a baseband circuit that is coupled to the radio frequency mixer. An adjustable first attenuator is in the feedback path of the radio frequency mixer circuit. And, a second attenuator is in the forward path of the radio frequency mixer. The radio frequency mixer circuit adjusts a carrier feed thru performance of both the baseband circuit and the radio frequency mixer. The first attenuator adjusts the power output of the radio frequency mixer and the second attenuator is adjusted to maintain a constant loop gain.

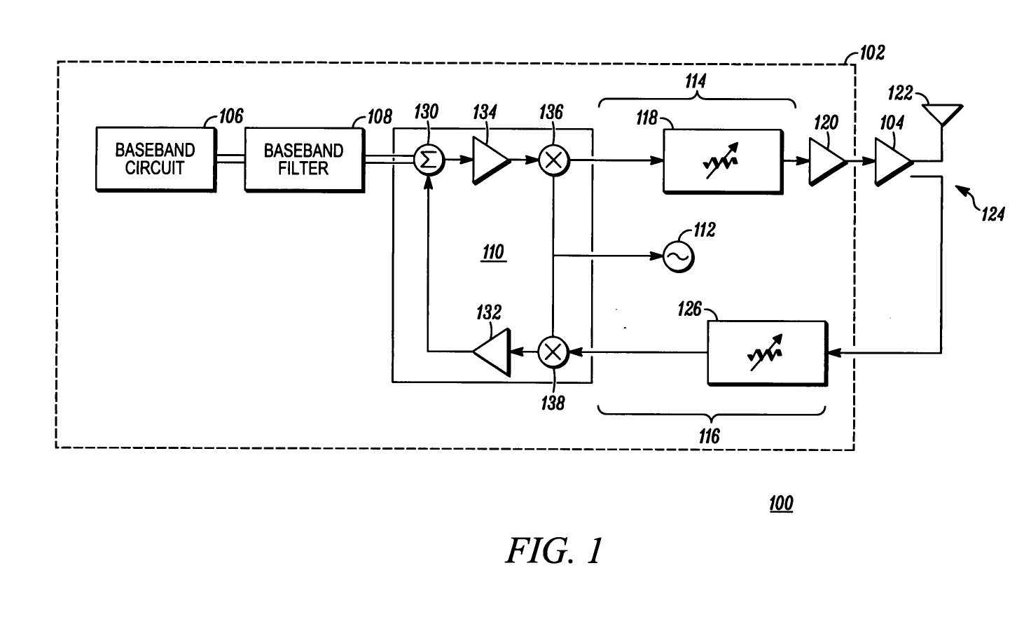

Referring now to the drawings, and in particular FIG. 1, an embodiment of a radio frequency transmitter 100 is shown. Transmitter 100 is a Cartesian feedback linear amplifier. Transmitter 100 includes an exciter 102 and a power amplifier 104. In one embodiment, transmitter 100 supports myriad modulation schemes, including for example, iDEN® (Integrated Digital Enhanced Network), TETRA (Terrestrial Trunked Radio), LSM (Linear Simulcast Modulation), C4FM (Constant Envelope 4-Level Frequency Modulation), Analog FM (Frequency Modulation), CQPSK (Compatible Quadrature Phase Shift Keying) and SAM (Scalable Adaptive Modulation). Therefore, ideally transmitter 100 maintains an acceptable carrier feed thru rejection level across a wide power range. A goal for worst case carrier feed thru rejection is −29 dBc or better for instance.

Exciter 102 includes a baseband circuit 106 that produces a baseband signal according to a predetermined modulation scheme(s). The baseband signal from the baseband circuit 106 is filtered by a baseband filter 108. Baseband filter 108 produces a filtered baseband signal for input to a radio frequency mixer circuit 110. Radio frequency mixer circuit 110 mixes the filtered baseband signal from the baseband filter 108 with a radio frequency signal from an oscillator 112. The radio frequency mixer 110 includes a forward path 114 and a feedback path 116. Forward path 114 is used to supply the radio frequency signal from the mixer 110 to the power amplifier 104. Feedback path 116 supplies a radio frequency signal coupled from power amplifier 104 to the mixer 110.

A forward path attenuator 118 receives the radio frequency signal from mixer 110 via forward path 114. Forward path attenuator 118 is adjustable in steps of less than 5 dB. In one embodiment, forward path attenuator 118 is adjustable in steps of 1 dB or less. However, it should be understood by those of ordinary skill in the art that the step sizes of attenuator 118 (and attenuator 126) may vary depending on the particular application and that other step sizes are included within the scope of the teachings herein. An exciter amplifier 120 receives the signal from forward attenuator 118 and amplifies the signal before delivering the signal to power amplifier 104. Power amplifier 104 is coupled to an antenna 122. Power amplifier 104 and antenna 122 emit the radio frequency signal from exciter amplifier 120.

A coupler 124 receives a signal emitted by power amplifier 104 and antenna 122. The signal received by the coupler is received by a feedback attenuator 126. Feedback attenuator 126 is adjustable in steps of less than 5 dB. In one embodiment, feedback attenuator 126 is adjustable in steps of 1 dB or less. The attenuated signal from feedback attenuator 126 is coupled to the feedback path 116 for mixer 110. In one embodiment, the adjustment of feedback attenuator 126 and forward path attenuator 118 is accomplished with a digital signal processor or microprocessor (not shown) under control of a stored program(s) or executable instructions.

Mixer 110 includes a summer 130. Summer 130 receives the filtered baseband signal from baseband filter 108. Typically this signal is composed of I (inphase) and Q (quadrature) pairs. The summer 130 also receives a baseband signal composed of I and Q pairs from amplifier 132. The output of the summer is an adjusted baseband signal consisting of the difference between the output of amplifier 132 and the output of baseband filter 108. Amplifier 134 provides substantial gain to the adjusted baseband signal such that the RF output at antenna 122 is a function of the summer input from baseband filter 108 and the feedback path gain consisting of gain summation from antenna 122 to the output of amplifier 132. Up converter 136 receives the adjusted baseband signal and mixes it with a radio frequency carrier from oscillator 112. Down converter 138 provides an inverse function to that provided by up converter 136. Down converter 138 extracts a radio frequency carrier from a signal received at feedback path 116 so that the resulting baseband signal may be used by summer 130 to adjust a filtered baseband signal.

Mixer 110 may be implemented as a single integrated circuit. In one embodiment, mixer 110 includes circuitry for adjusting DC offset automatically. In particular, DC offset is nullified using a successive approximation algorithm, which is a variation of the bisection algorithm used for finding the roots of equations. The automatic adjustment of DC offset is also referred to as DC training. During DC training the external input to summer 130 is normally disconnected from the mixer 110. Then a training algorithm adjusts the DC offset in a training mode. This adjusts the carrier feed thru components from the mixer 110. In accordance with an embodiment of the present invention, instead of disconnecting the external inputs to summer 130, the training algorithm is run when the summer inputs are connected to the baseband filter 108 and the baseband circuit 106. In this manner, the training algorithm not only adjusts the DC offset for the mixer 110, but it also adjusts the DC offset contributions for the baseband circuit and the baseband filter as well. Accordingly, carrier feed thru rejection is performed.

In one embodiment mixer 110 includes attenuators (not shown) in the forward and feedback path. These attenuators are used in the DC training to adjust the carrier feed thru rejection. These attenuators are distinguishable from the forward path attenuator 118 and the feedback path attenuator 126, at least in that the attenuators included with mixer 110 are adjusted in coarse steps, for example, steps of 5 dB or greater.

In some embodiments, there may be a limitation on the amount of DC offset that the mixer 110 can adjust during DC training. For example, a mixer circuit may be limited to −30 dBc. In that case, adjustments to power may be done in the baseband circuit, but this has the undesirable affect of not running the baseband circuit 106 at its full dynamic range where it has the best noise performance. In addition, reductions in power at the baseband circuit can cause a dB for dB degradation in the ability of the mixer to eliminate the DC. Hence, according to an embodiment of the invention, a feedback attenuator is used to adjust the transmitter power instead of adjusting the baseband circuit 106 to adjust transmitter power. More specifically, feedback attenuator 126 is adjusted in steps of about 5 dB or smaller to adjust the transmitter power. To obtain loop stability, the feed forward attenuator 118 is adjusted in an amount substantially equal to the attenuation of feedback attenuator 126. Placing this fine attenuation adjustment in the feedback and forward path of the mixer advantageously does not restrict the input power to the mixer, thereby permitting optimal operation of the mixer 110. In other words, the baseband circuit 106 is permitted to operate in a manner that requires no adjustments, which allows the output of the baseband circuit 106 to maintain a substantially constant power level.

Feedback attenuator 126 and forward path attenuator 118 are implemented in any known manner. An exemplary attenuator for use as feedback attenuator 126 or forward path attenuator 118 is the HMC468LP3 attenuator, available from Hittite Microwave Corporation, Chelmsford, Mass.

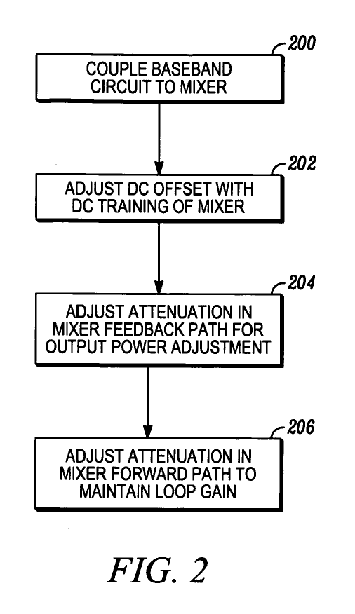

FIG. 2 is a flow diagram of a method for improving carrier feed thru rejection in accordance with embodiments of the present invention. The method is described below with reference to the embodiments shown in FIG. 1. In one embodiment, this method is executed during a communications slot of a transmitter during normal operation of the transmitter, therefore not requiring system downtime for improving carrier feed thru rejection.

According to the method, a baseband circuit is coupled to a radio frequency mixer (200). For example, baseband circuit 106 is coupled to mixer 110 through baseband filter 108. Or baseband circuit 106 may be coupled directly to mixer 110 without baseband filter 108.

After coupling the baseband circuit to the mixer (200), the mixer executes DC training that may be inherent to the mixer (202). This adjusts the DC offset associated with the mixer and the baseband circuit, at least within any limitations of the DC training capabilities of the mixer. For example, if mixer 110 can adjust its DC offset by −30 dB, then the mixer 110 can adjust the DC offset of mixer 110, baseband circuit 106 and baseband filter 108, collectively, by −30 dB. In one embodiment, the mixer 110 accomplishes DC training in 50 microseconds or less.

To adjust the output power of the transmitter, the attenuation in the feedback path of the mixer is adjusted in relatively fine steps (204). In the embodiment of FIG. 1, this is accomplished by adjusting the feedback attenuator 126 in steps of about 1 dB and less than about 5 dB to obtain carrier feed thru rejection of about −35 dBc to −29 dBc. To maintain loop gain, attenuation in the forward path is adjusted (206). In one embodiment, the adjustment of attenuation in the forward path is substantially the same as the attenuation adjustment made in the feedback path. In the embodiment shown in FIG. 1, this is accomplished by adjusting the forward path attenuator 118 in steps of about 1 dB and less than about 5 dB.

In one embodiment, the steps of the method of FIG. 2 are accomplished under control of a stored program executed on a digital signal processor or microprocessor or the like. Alternatively, a state machine or hard-wired logic is used to control the steps of the method of FIG. 2.

According to the principles of the present invention, carrier feed thru rejection is improved by using the DC training capabilities of a radio frequency mixer to adjust the DC offset of the radio frequency mixer and any baseband circuit or baseband filtering coupled to the radio frequency mixer. This advantageously permits the radio frequency mixer to operate at optimal efficiency. This also improves adjacent channel couple power. And, since the DC training of the mixer is relatively fast, no system downtime is required for carrier feed thru rejection. Also, adjustments for carrier feed thru rejection during operation, for example, due to changes in temperature, may be made frequently.

In the foregoing specification, specific embodiments of the present invention are described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A transmitter comprising:
a radio frequency mixer that mixes a baseband signal with a radio frequency signal;
a baseband circuit coupled to an input of the radio frequency mixer to provide the baseband signal at a substantially constant level to the radio frequency mixer;
a first adjustable attenuator in a feedback path of the radio frequency mixer;
a second adjustable attenuator in a forward path of the radio frequency mixer;
a power amplifier coupled to the second attenuator,
wherein the first attenuator is coupled to receive an output of the power amplifier; and
wherein the fast attenuator and the second attenuator are adjustable in steps of less than 5 dB.

2. The transmitter of claim 1 wherein the first attenuator and the second attenuator are coupled to a processor that adjusts the level of attenuation.

3. The transmitter of claim 2 wherein the baseband circuit includes a baseband filter.

4. The transmitter of claim 1 wherein the radio frequency mixer includes a circuit for adjusting carrier feed thru rejection and wherein the circuit for adjusting carrier feed thru rejection in the radio frequency mixer is used to adjust a carrier feed thru rejection for a combination of the radio frequency mixer and the baseband circuit.

5. The transmitter of claim 1 wherein the first attenuator and the second attenuator are adjustable in steps of about 1 dB or less.

6. The transmitter of claim 5 wherein the second attenuator is adjusted as a function of the first attenuator.

7. The transmitter of claim 1 wherein a carrier feed thru rejection for the transmitter is −35 to −29 dBc.

8. The transmitter of claim 1 wherein a carrier feed thru rejection for the transmitter is −35 to −29 dBc for plural modulation arrangements for the baseband circuit.

9. The transmitter of claim 1 wherein the power amplifier is coupled to the radio frequency mixer through the second attenuator.

10. A method for improved carrier feed thru rejection comprising the steps of:
mixing a baseband signal with a radio frequency signal using a radio frequency mixer, wherein the baseband signal is maintained at a substantially constant level;
adjusting a carrier feed thru rejection performance of the radio frequency mixer when the baseband signal is coupled to the radio frequency mixer;
adjusting an attenuation in a feed back path of the radio frequency mixer with a first adjustable attenuator, wherein the first adjustable attenuator is adjustable in steps of less than 5 dB; and
adjusting an attenuation in a forward path of the radio frequency mixer with a second adjustable attenuator, wherein the second attenuator is adjustable in steps of less than 5 dB.

11. The method of claim 10 further comprising the step of adjusting the first attenuator to adjust an output power, and adjusting the second attenuator in relation to the first attenuator.

12. The method of claim 10 wherein the steps of the method are executed during a communications slot of a transmitter during normal operation.

13. The method of claim 10 further comprising the steps of:
amplifying a signal from the second attenuator to produce an amplified signal; and
coupling the first attenuator to receive the amplified signal.

14. An apparatus for carrier feed thru rejection in a transmitter comprising:
a radio frequency mixer that mixes a baseband signal with a radio frequency signal;
a baseband circuit coupled to an input of the radio frequency mixer to provide the baseband signal at a substantially constant level to the radio frequency mixer;
a first adjustable attenuator in a feedback path of the radio frequency mixer;
a second adjustable attenuator in a forward path of the radio frequency mixer;
wherein the first attenuator and the second attenuator are adjustable in steps of less than 5 dB.

15. The apparatus of claim 14 further comprising a power amplifier coupled to the second attenuator, wherein the first attenuator is coupled to receive an output of the power amplifier.

16. The apparatus of claim 14 wherein the first attenuator and the second attenuator are coupled to a processor that adjusts the level of attenuation.

17. The apparatus of claim 14 wherein the first attenuator and the second attenuator are adjustable in steps of about 1 dB or less.

18. The apparatus of claim 14 wherein the second attenuator is adjusted as a function of the first attenuator.

19. The apparatus of claim 14 wherein a carrier feed thru rejection for the apparatus is −35 to −29 dBc.
